(19) United States
(12) Patent Application Publication
(10) Pub. No.: US 2003/0137533 A1
(43) Pub. Date: Jul. 24, 2003

(54) Controlling method using graphical user interface

(76) Inventors: Naomi Yamazaki, Kawasaki (JP); Yosuke Katagiri, Kawasaki (JP); Akihiko Hanawa, Kawasaki (JP); Masato Miyata, Kawasaki (JP); Hideki Dake, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/329,294

(22) Filed: Dec. 24, 2002

(30) Foreign Application Priority Data
Jan. 8, 2002 (JP) 2002-001207

(51) Int. Cl. G09G 5/00; G06F 15/173

(52) U.S. Cl. 345/736; 709/223

(57) ABSTRACT

A method of performing a control operation on a target apparatus in a network including a step of creating a function information file describing control functions of the target apparatus, a step of forming a control window by gathering control functions stored in the function information file, a step of storing the control window in a performance information file, and a step of performing control operations by retrieving the control window from the performance information file. The method prepares beforehand the function information file that stores information of various functions of the target apparatuses and their platforms. The window for controlling the target apparatuses can be created by cutting and pasting necessary control functions from the function information file to the control window. The control functions created in the window are stored in the performance information file. A function performance unit retrieves a control function to perform the control operation accordingly.

### BACKGROUND OF THE INVENTION

1. Field of the Invention

The present invention generally relates to a method of performing a control operation, and more particularly, to a method of performing a control operation wherein the creation of a system control screen (window) is easy and the efficient reduction in the occurrence of program bugs is possible in the system control operation using the system control screen.

2. Description of the Related Art

In a conventional development of a network management system (NMS) that enables efficient control of a large scale network, some problems still remain unsolved.

When a control terminal performs various control operations to control apparatuses under the control of the control terminal, the control terminal first transmits a command to the apparatuses and the apparatuses return information in response to the command so that the control terminal can display the information on a control screen and enter the information in a database. The apparatuses under the control of the control terminal, however, are different in specifications. The command that the control terminal transmits to each apparatus may be different apparatus by apparatus depending on the specification of the apparatus. Thus, a control program tuned for each apparatus is conventionally developed.

The development of the control programs takes a long time and incurs a large cost since each control program is developed separately due to the difference in control objects and platforms of the apparatuses that the control program controls. Since control programs are developed separately by different engineers, each control program may contain different bugs. Sustaining a certain level of quality of the developed control programs is difficult due to the difference in the capabilities of the engineers. Furthermore, the debugging of the developed control programs further delays the completion of the development because the function of each control program needs to be verified individually.

The Japanese Laid-open Patent Application No. 5-204858 discloses a control system that efficiently controls multimedia apparatuses having different external control specifications. The control system creates control commands and stores the control commands in a command file beforehand. The control system retrieves a control command from the command file in response to a request from a data input/output apparatus and transmits the retrieved control command to a control object apparatus. The parameters of the control command are unchangeable. If a user desires to change the parameters, the user is required to create a new command. In the case wherein many combinations of parameters exist, the creation of the new command may take a long time. The user may not be able to customize an operational screen (window) depending on differences in the control objects' specifications.

### SUMMARY OF THE INVENTION

Accordingly, it is a general object of the present invention to provide a novel and useful method of performing control operation that solves the above problem, and more particularly, to provide a method of performing control operation wherein control screens (windows) corresponding to control object apparatuses having different specifications are created without difficulties and the control operation of a network system is easily and smoothly performed using the created control screens.

To achieve the above object, a method of performing a control operation on a target apparatus, according to the present invention, includes a step of creating a function information file describing control functions of said target apparatus, a step of forming said control operation by gathering control functions stored in said function information file, a step of storing said control operation in a performance information file, and a step of performing said control operation by retrieving control windows from said performance information file.

That is, the method according to the present invention prepares beforehand the function information file that stores information of various functions of the target apparatuses and their platforms. A control window for controlling the target apparatuses can be created by cutting and pasting necessary control functions from the function information file to the control window. The control functions created in the control window are stored in the performance information file. A function performance unit retrieves a control function to perform the control operation accordingly.

Since only the function information file depends on the various specifications of target apparatuses and the function performance unit is common to all the target apparatuses, the creation of a control program for apparatuses having various specifications and/or platforms becomes easier. The possibility of program bugs is reduced because the performance information file is created through a cut-and-paste process using a graphical user interface.

Other objects, features, and advantages of the present invention will become more apparent from the following detailed description when read in conjunction with the accompanying drawings.

### BRIEF DESCRIPTION OF THE DRAWINGS

FIG. 1 is a schematic diagram showing a network system according to an embodiment of the present invention;

FIG. 2 is another schematic diagram showing the network system showed in FIG. 1;

FIG. 3 is a flow chart showing a series of control operations according to an embodiment of the present invention;

FIG. 4 is another flow chart showing a series of control operations according to an embodiment;

FIG. 5 is a flow chart showing the creation of a function information file and a performance information file used in a network control system according to an embodiment of the present invention;

FIG. 6A is a data diagram showing a transmission frame transmitted by a network control system according to an embodiment of the present invention;

FIG. 6B is a data diagram showing a response frame received by a network control system according to an embodiment of the present invention;

FIG. 7A is a schematic diagram showing a method of editing the function information of a network control system according to an embodiment;

FIG. 7B is a schematic diagram showing a function performance unit according to an embodiment;

FIG. 8 is a schematic diagram showing an example of a performance information file of a network control system according to an embodiment;

FIG. 9 is a flow chart showing a managerial operation of a network management system according to an embodiment of the present invention;

FIG. 10 is an example of a function information file according to an embodiment;

FIG. 11 is an example of a performance information file according to an embodiment;

FIGS. 12A and 12B are schematic diagrams showing a process in which a performance information file is created according to an embodiment;

FIGS. 13A and 13B are schematic diagrams showing a process in which a performance information file is created according to an embodiment;

FIGS. 14A and 14B are schematic diagrams showing a process in which a performance information file is created according to an embodiment;

FIGS. 15A and 15B are schematic diagrams showing a process in which a performance information file is created according to an embodiment;

FIG. 16 is a schematic diagram showing an information frame according to an embodiment;

FIG. 17 shows a function ID table according to an embodiment;

FIG. 18 shows an operation table according to an embodiment;

FIG. 19 shows a managed object table according to an embodiment;

FIG. 20 shows an apparatus table according to an embodiment;

FIG. 21 shows a parameter-floor 1 table according to an embodiment;

FIG. 22 shows a parameter-floor 2 table according to an embodiment;

FIG. 23 shows a parameter-group table according to an embodiment;

FIG. 24 shows a parameter-apparatus number table according to an embodiment;

FIG. 25 shows a parameter-IP address table according to an embodiment;

FIG. 26 shows a command response-setup table according to an embodiment;

FIG. 27 shows a command response-reading table according to an embodiment;

FIG. 28 shows a command response-deleting table according to an embodiment;

FIG. 29 shows a “waiting for response” dialog table according to an embodiment;

FIGS. 30A, 30B, and 30C show display item tables according to an embodiment;

FIG. 31 shows a character classification table according to an embodiment; and

FIG. 32 shows a specific description table according to an embodiment.

### DETAILED DESCRIPTION OF THE PREFERRED EMBODIMENTS

A detailed description of the preferred embodiments will be given below by reference to the drawings.

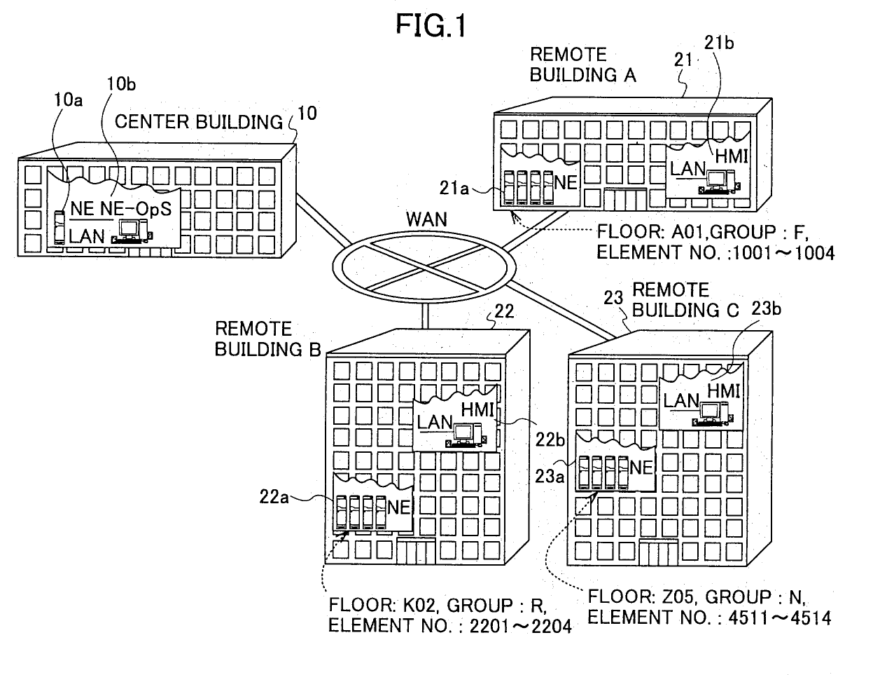

FIG. 1 is a schematic diagram illustrating network system control by a network control system according to an embodiment of the present invention.

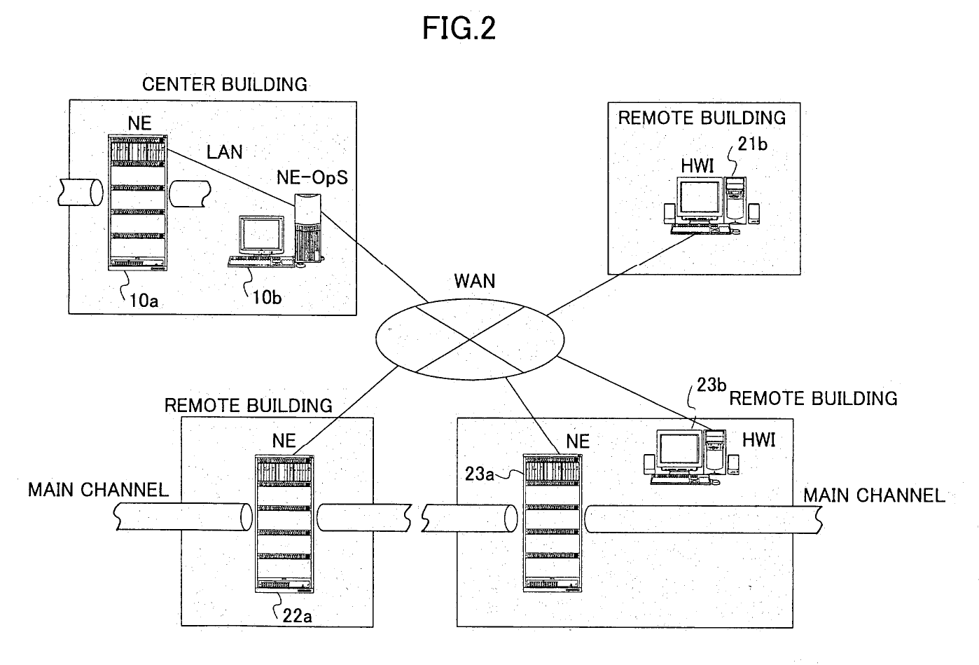

As showed in FIG. 1, the network system includes separate network apparatuses 10a, 21a, 22a, 23a located in separate buildings 10, 21, 22, 23, respectively. As showed in FIG. 2, these network apparatuses are connected to a main channel and handle communications. These network apparatuses are further connected to operator terminals such as a server 10 b and clients 21b, 22b, 23b, respectively, through a communication channel such as a LAN. The network apparatuses and the operator terminals are connected each other through a communication channel such as a WAN.

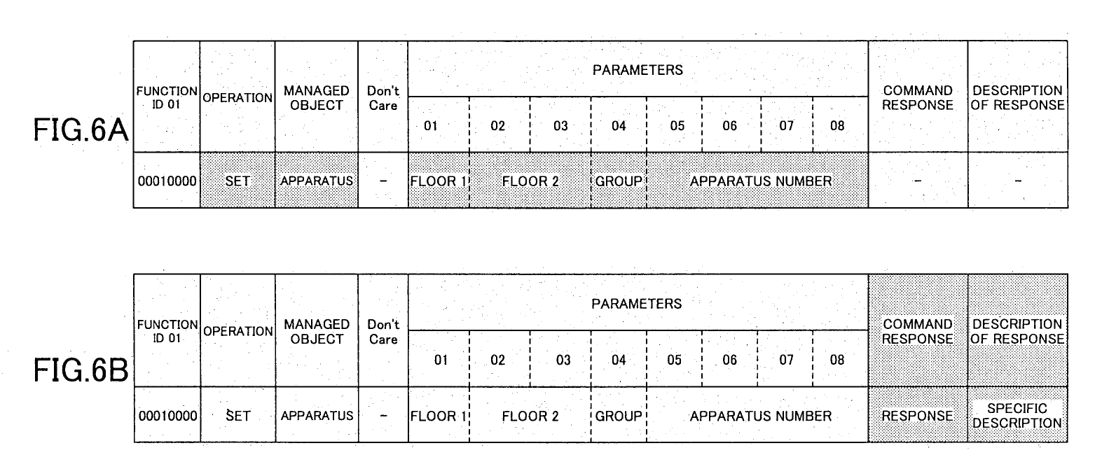

In the large scale network system as showed in FIGS. 1 and 2, a control program is installed in the server 10b (or in each client 21b, 22b, 23b) to control the network apparatuses. An operator or a system administrator transmits a certain control frame (showed in FIG. 6A) to each network apparatus 21a, 22a, and 23a by operating the server 10b. A computer associated with each network apparatus returns a response frame (showed in FIG. 6B) indicating various statuses of the network apparatus in response to the control frame. The server 10b receives the response frames from the computers controlling the network apparatuses based on apparatus status.

The control program installed in the server includes a program to display a control screen (window) generated by a method of performing control operation according to an embodiment of the present invention. The operator is required to register each control object apparatus (network apparatuses 21a, 22a, 23a, . . . ) by following the control screens displayed on the monitor of the server by the program. The above control program installed in the server automatically generates and transmits control frames corresponding to the specifications of each network apparatus.

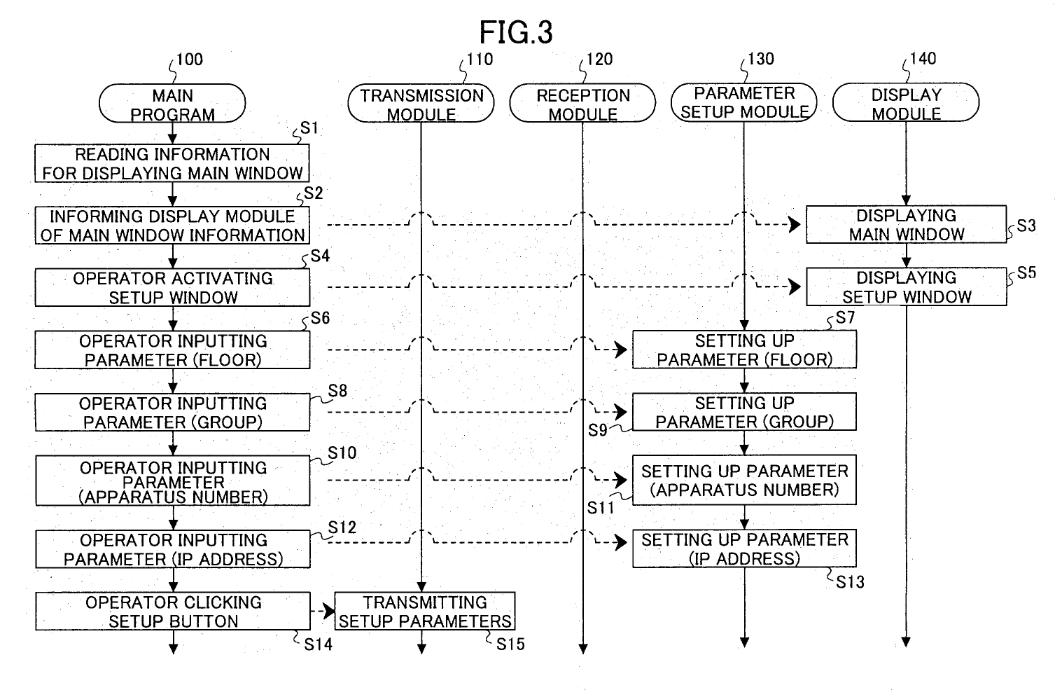

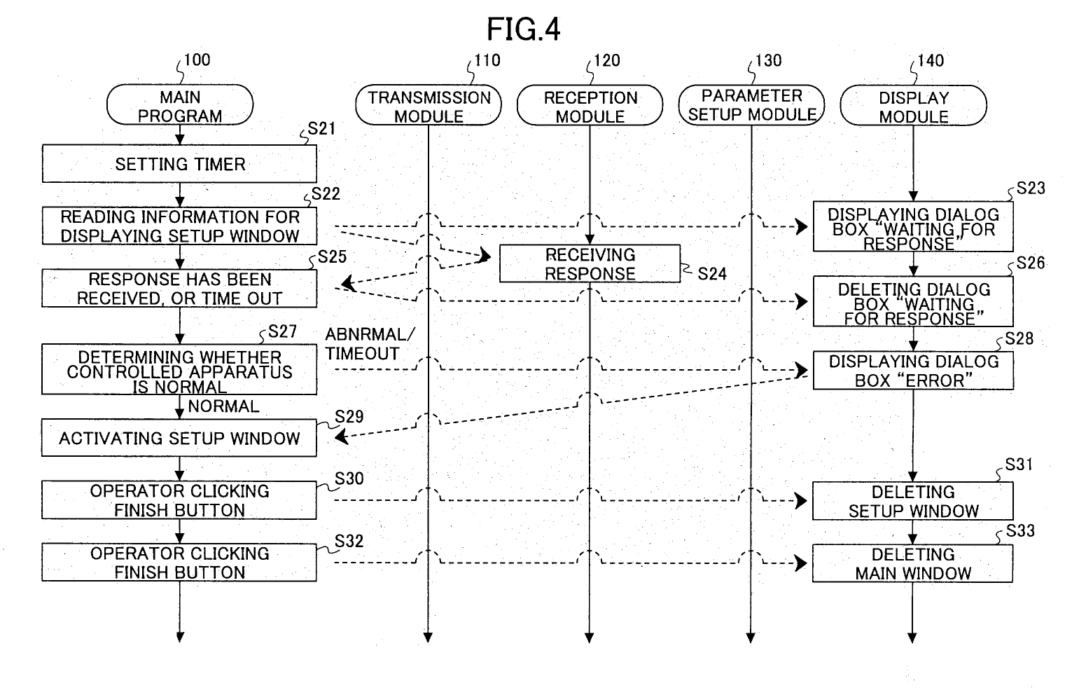

FIGS. 3 and 4 are sequence diagrams showing a series of operations of the server 10b. The server 10b generates a control frame (transmitting frame) for each network apparatus in response to the operation of the operator and transmits the control frame to each network apparatus. Each network apparatus receives the control frame from the server 10b and returns a response frame to the server 10b. The server 10b performs certain control operations in response to the receipt of the response frame from each network apparatus.

As showed in FIGS. 3 and 4, function performance unit 200 (software) enables the operator to perform a control operation using control screens created according to an embodiment. The function performance unit 200 includes main program 100, transmission module 110, reception module 120, parameter set-up module 130, and display module 140. The function performance unit 200 is installed in a hard disk drive of the server, for example. The function performance unit 200 reads a performance information file created for each control object remote building customized by the method according to the present invention, and performs control operation based on the performance information file as showed in FIGS. 3 and 4.

Main program 100 of function performance unit 200 reads information to be displayed in the main window from the performance information file, and loads the information in memory (Step S1). Main program 100 informs display module 140 of the information to be displayed in the main window (Step S2). Display module 140 displays the information in the main window (not shown) displayed on the monitor of the server (Step S3).

In the main window displayed on the monitor of the server, the operator can make a selection of various windows including a selection window in which the operator can set up parameters, for example. In response to the operator's selection, main program 100 has display module 140 to display the selection window on the monitor of the server (Steps S4 and S5).

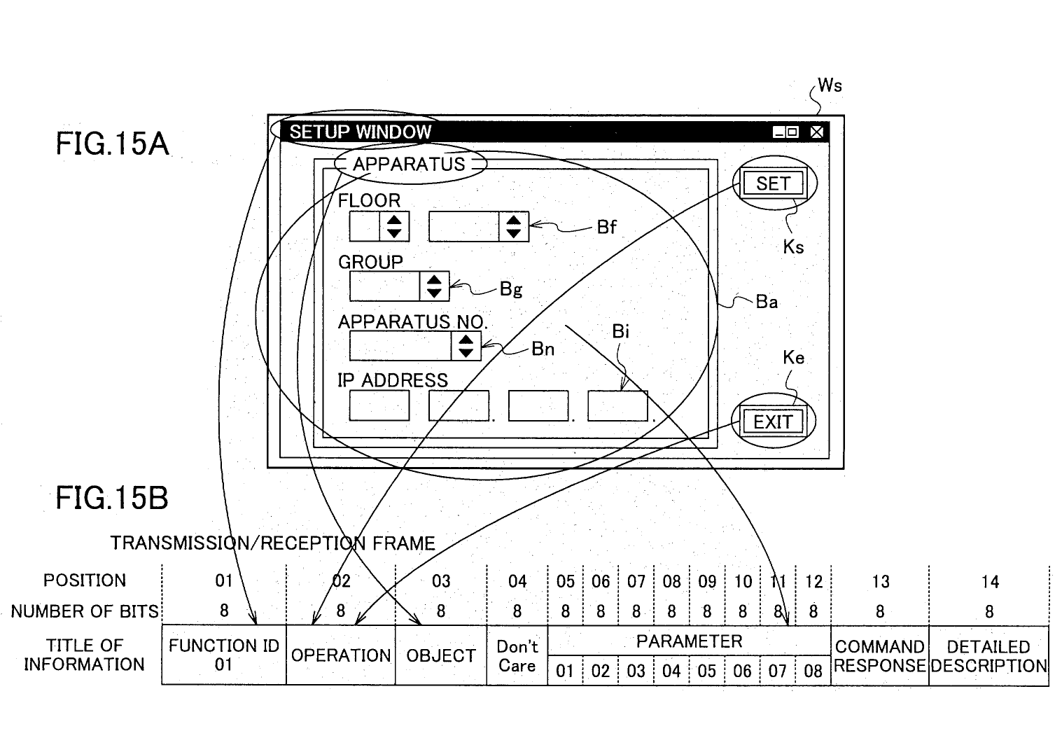

In the selection window displayed on the monitor of the server, the operator is required to input various parameters. In the example showed in FIG. 15, main program 100 requests the operator to input the floor where the control object apparatus is located, a group number, an apparatus number, and an IP address of the control object apparatus. When the operator inputs the floor where the control object apparatus is located in response to the main program's request (Steps S6), parameter setup module 130 stores the item of information at a corresponding position of a control frame format (showed in FIG. 6A) prepared in the memory of the server. In the same manner, the other information, that is, the group number, the apparatus number, and the IP address, input by the operator is received by main program 100 and stored in corresponding positions of the control frame format prepared in the memory of the server (Steps S8, S9, S10, S11, S12, and S13).

After inputting the required information, the operator clicks setup button Ks in the selection window showed in FIG. 15A (Step S14). In response to the click on setup button Ks, transmission module 110 transmits the control frame prepared in the memory of the server, containing parameters as described above (Step S15). In this embodiment, the control frame is transmitted to the IP address of the control object apparatus via WAN/LAN. In another embodiment, any network protocol may be used.

An IP address is assigned to each control object apparatus. The above control frame (setup frame) is received by the control object apparatus designated by the IP address contained in the control frame. In response to the reception of the control frame, the control object apparatus diagnoses itself based on the parameters. If the control object apparatus diagnoses itself as normal and is at least in standby state, the control object apparatus returns to the server a response frame (showed in FIG. 6B) indicating that the control object apparatus is normal. If the control object apparatus diagnoses itself as normal but is not in the standby state, the control object apparatus sends a response frame indicating that the control object apparatus is unable to set up. If the control object apparatus diagnoses itself abnormal, the control object apparatus sends a response frame indicating that the control object apparatus is unable to setup. The response is sent to the IP address of the sender of the control frame. The server determines whether the information items other than shaded ones in the response frame as showed in FIG. 6B match corresponding information items in the control frame to ensure that the response frame is a response to the control frame transmitted by the server. If the information items match, the server further checks the shaded information items.

If the description of response in the response frame showed in FIG. 6B indicates that the control object apparatus is normal, the server displays a setup window to let the operator set up the control object apparatus.

If the description of response in the response frame showed in FIG. 6B indicates that the control object apparatus is unable to set up, the server displays a message indicating that the control object apparatus is abnormal, and then displays the setup window.

The function information file stores the specifications of network elements managed by the server in various tables (pattern) according to this embodiment. The performance information file is created based on the function information file as will be described later in detail. The function performance unit 200 is designed so that it accepts only an input that complies with the pattern. Any input that does not comply with the pattern is rejected. If an improper input is made, the function performance unit 200 may display an error message and may not have step S14 completed. Accordingly, the contents of the information frame transmitted to the managed apparatus automatically fits the specifications thereof. The managed apparatus can respond to the information frame immediately.

As described above, the controlled apparatus performs a certain operation in response to the control frame transmitted by the server and returns a response frame to the server. This series of operations will be described by reference to FIG. 4. The controlled apparatus receives the control frame (setup frame) and checks various state signals of the controlled apparatus itself. The controlled apparatus indicates the result of the checking of the various state signals in the command response column and the response description column in a response frame, and returns the response frame to the server.

As showed in FIG. 4, main program 100 sets a timer for measuring time since the setup frame is transmitted in step S15 (step S21). Main program 100 further reads the information about transition in the performance information file (step S22). Main program 100 determines whether the response frame has been received. If the response frame has not been received from the controlled apparatus, display module 140 displays “waiting for response” dialog on the monitor of the server (step S23). If the response frame has been received, reception module 120 receives the response frame (step S24).

Main program 100 determines whether the response frame has been received by reception module 120 or the response frame is not received within the time limit (step S25). If the response frame indicates that the controlled apparatus is normal, main program 100 transits to the setup window (step S29). If the response frame indicates that the controlled apparatus is abnormal or is not received within the time limit, display module 140 displays an error dialog (step S28).

The operator registers the next controlled apparatus in the same manner as described above by using the setup window. Once the operator completes the registration of the controlled apparatuses, the operator clicks the “finish” button Ke showed in FIG. 15A to close the setup window. In response to clicking, display module 140 deletes the setup window from the monitor and displays the above main window (step S31). If the operator desires to control any other apparatus, the operator can open a setup window corresponding to the apparatus and control the apparatus. Once the operator finishes controlling all apparatuses that the operator desires to control, the operator has main program 100 close the main window (step S32). Display module 140 deletes the main window off the monitor of the server (step S33).

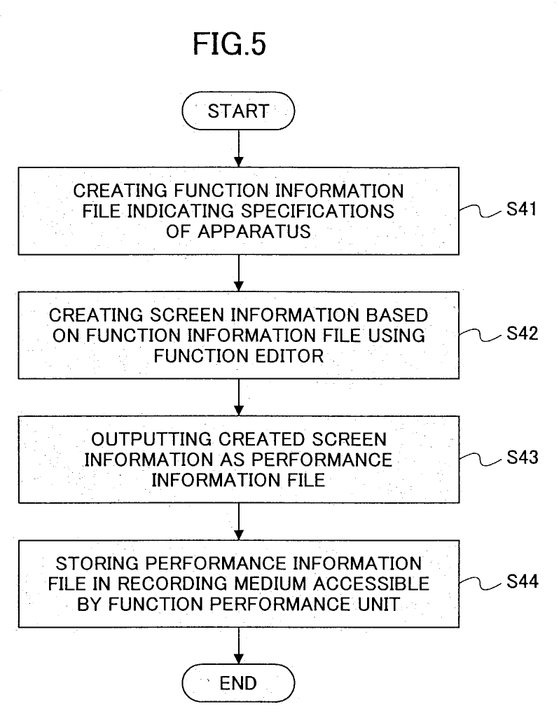

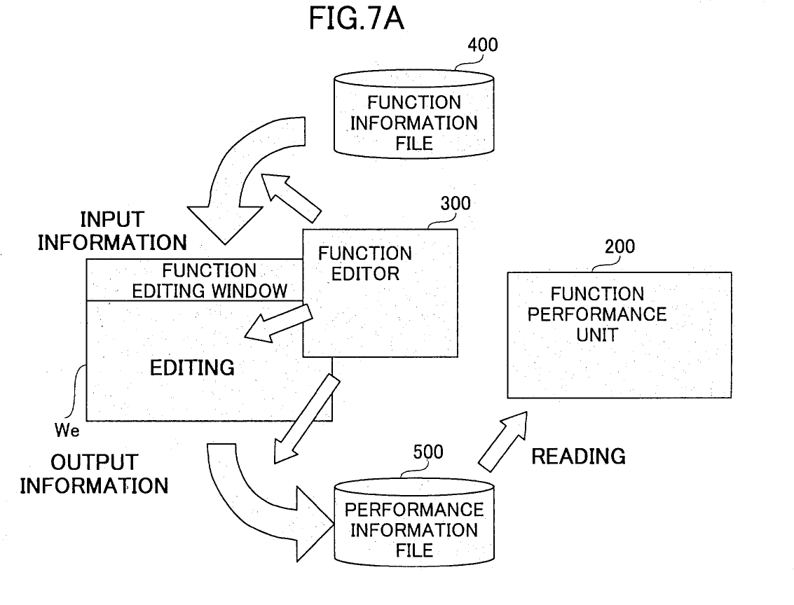

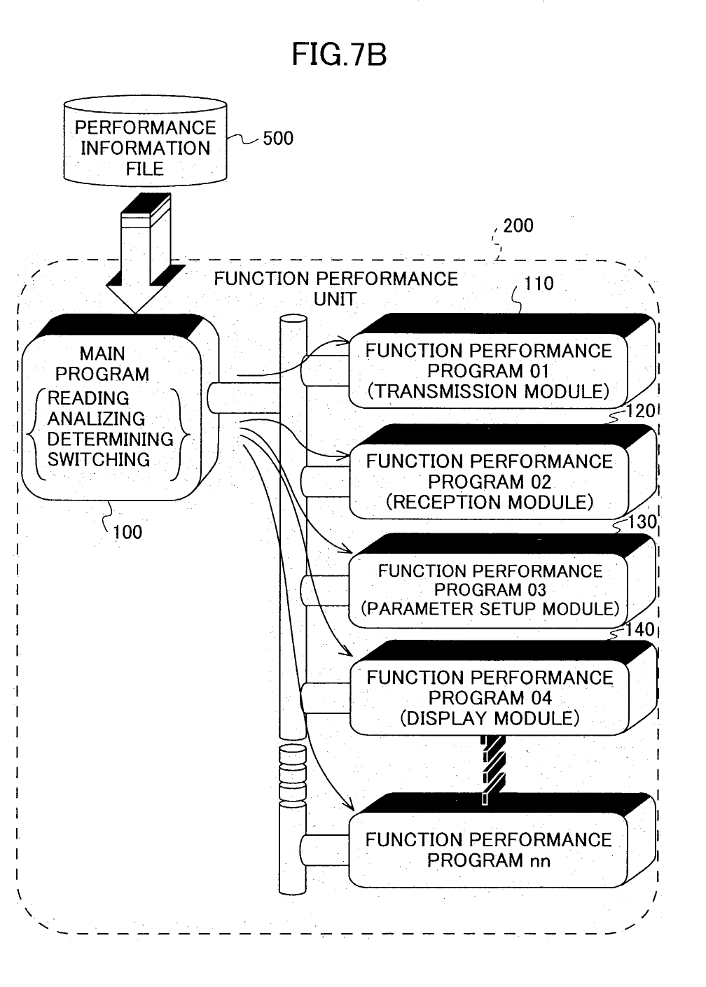

FIG. 5 is a flow chart showing the creation of the above performance information file according to an embodiment of the present invention. The function information file 400 (showed in FIG. 7) is created based on the specifications of a controlled apparatus (step S41).

Based on the function information file 400, performance information file 500 (showed in FIG. 7) is created by editing the setup window (showed in FIG. 15A) using function editor 300 (showed in FIG. 7)(step S42).

The performance information file 500 is output (step S43), and stored in a preferable recording medium (step S44).

The function information file 400 is created based on the specifications of the controlled apparatus (including the information about the platform and the interface of a computer embedded in the controlled apparatus). Accordingly, the performance information file 500 that is created based on the function information file 400 using the function editor 300 automatically complies with the specifications of the controlled apparatus. The control frame (setup frame) also automatically complies with the specifications of the controlled apparatus since the control frame is generated as a result of the registration of the controlled apparatus as described by reference to FIGS. 3 and 4. The controlled apparatus can process the setup frame as soon as the controlled apparatus receives the setup frame. In addition, function performance unit 200 reads performance information file 500 and performs each function sequentially in accordance with functions and transition destinations indicated in the performance information file. As a result, function performance unit 200 enables the operator to perform a desired control operation.

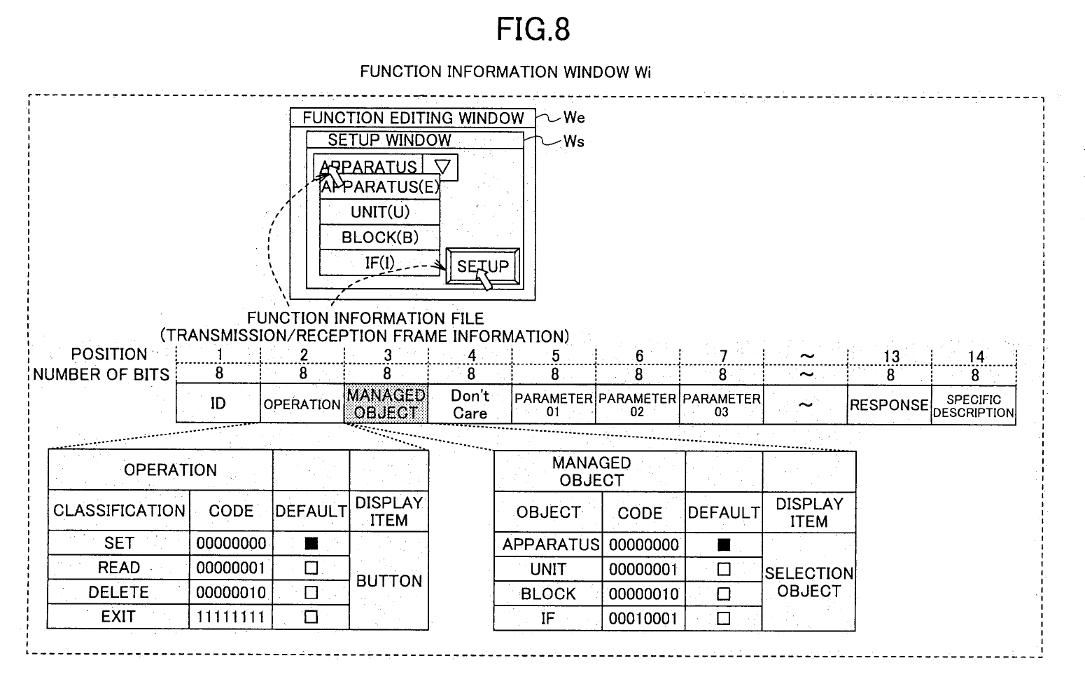

By reference to FIG. 8, the creation of a setup window, that is, the creation of a performance information file according to an embodiment of the present invention will be described. This example is the case wherein, as described above by reference to FIGS. 3 and 4, a setup window is created for controlling a controlled apparatus by transmitting a control frame to the controlled apparatus and receiving a response frame returned by the controlled apparatus in response to the control frame.

At first, the specification of the performance information file is created as the function information file 400. The specification includes the interface of the controlled apparatus, the shape and other specifications of a window, dialog box, and button, and functions performed to implement the specifications.

Next, the operator can obtain an item of information from the function information file 400 and arrange it in the function information window (showed in FIG. 8) using function editor 300. Specifically, the operator can click function information showed in a function information window Wi indicating the contents of function information file 400, and drop at any position in function editorial window We (in setup window A (Ws) in function editorial window We). In the example showed in FIG. 8, the operator drags “CONTROL” at the position “3” in the function information window Wi and drops at an arbitrary position in the setup window A (Ws). After dropping the “CONTROL”, the operator can display a pull-down menu of candidates to be “controlled” contained in the control information by right-clicking. The operator can select a desired object out of the candidates. In this example, the operator selects “apparatus” that is a default value.

In the same manner, the operator drags “FUNCTION” at a position “2” and drops the “FUNCTION” at an arbitrary position in the setup window A (Ws). The operator right-clicks to pull-down the menu of candidates of “FUNCTION” and selects one of the candidates. In this example, the operator selects “setup” that is a default value.

The operator can create the performance information file 500 by arranging various information items in the function editorial window We using the function editor 300 and storing the information of the setup window as a file.

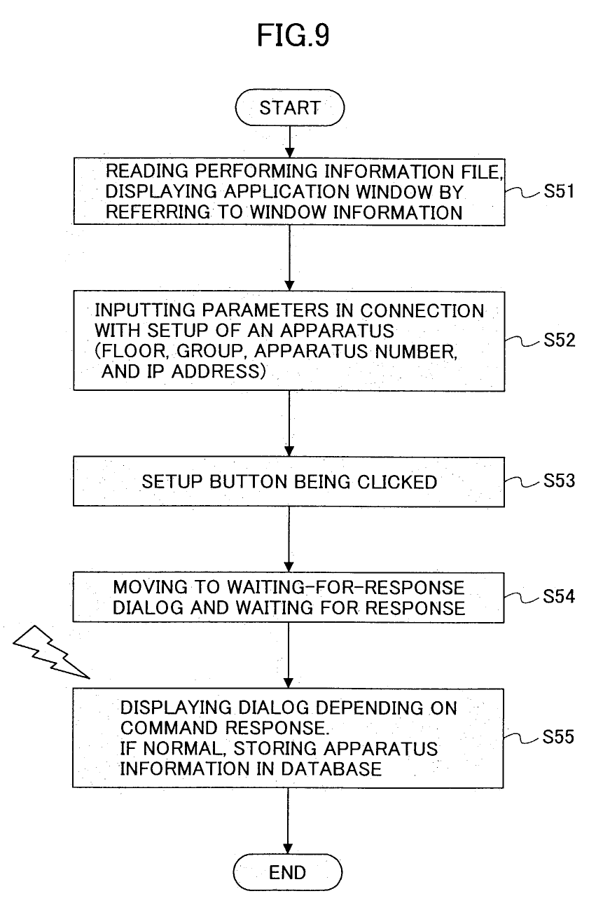

FIG. 9 is a flow chart showing the registration process of apparatuses that is performed by the operator. This flow chart corresponds to that of the server showed in FIGS. 3 and 4. The function performance unit 200 reads the performance information file 500 and displays the setup window Ws (apparatus setup window in this case) as showed in FIG. 15A based on the information stored in the performance information file 500 (step S51). The operator inputs parameters such as a floor number of a remote building, apparatus group number, apparatus number, and IP address of the apparatus, in corresponding setup boxes in the setup window (step S52). The operator clicks “SETUP” button Ks when the operator completes inputting (step S53). The server automatically transmits a control frame input by the operator to the designated IP address.

The function performance unit 200 displays a dialog box “Waiting for response”, and waits for a response frame returned by the controlled apparatus (step S54). In response to the reception of the response frame, the function performance unit 200 displays a certain dialog box depending on the contents of the response frame. If the response frame indicates that the controlled apparatus is normal, the function performance unit 200 stores the information about the controlled apparatus in a predetermined database.

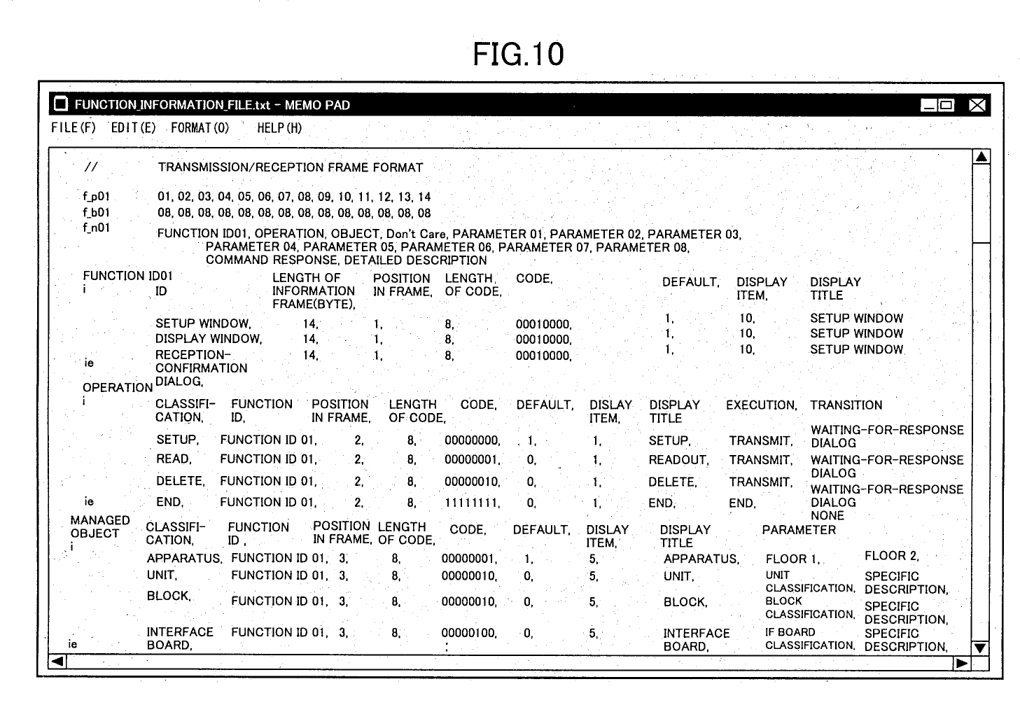

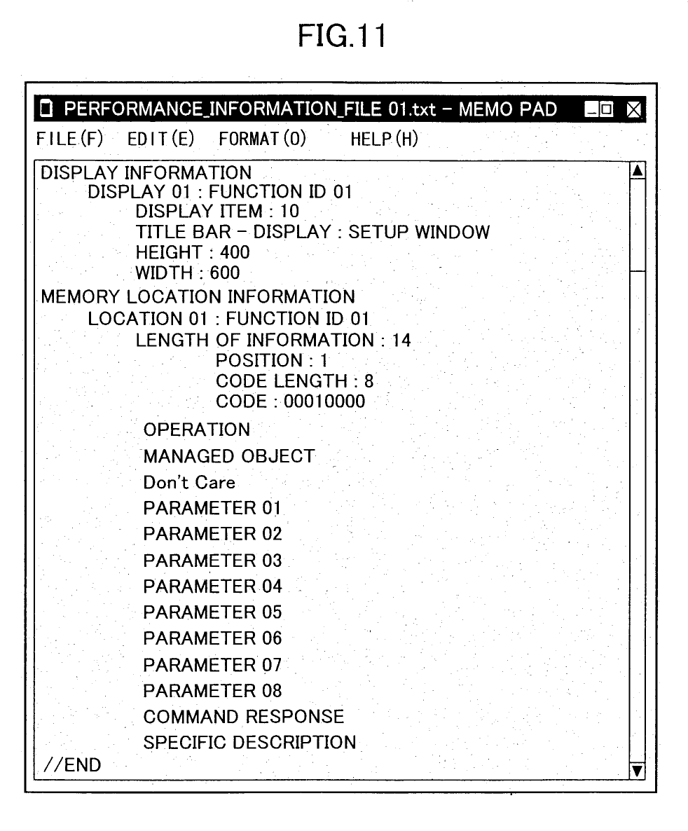

FIG. 10 is an example of the function information file 400, and FIG. 11 is an example of the performance information file 500.

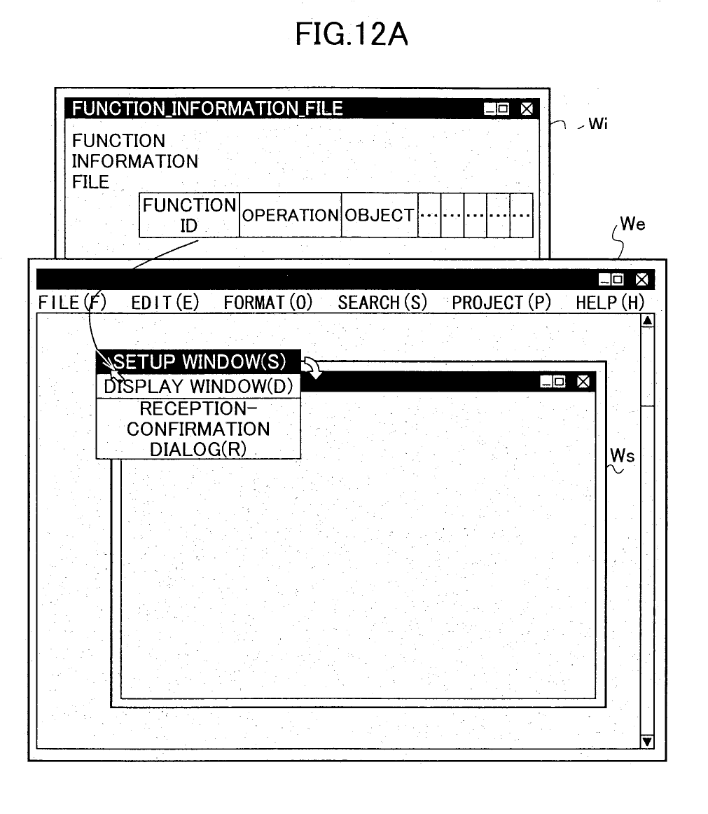

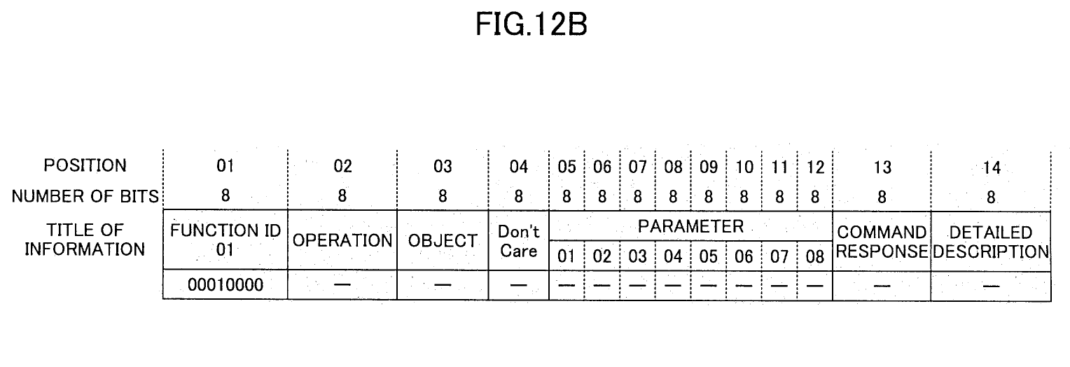

The specific procedure to create the apparatus setup window Ws showed in FIG. 15A will be described by reference to FIGS. 12, 13, and 14.

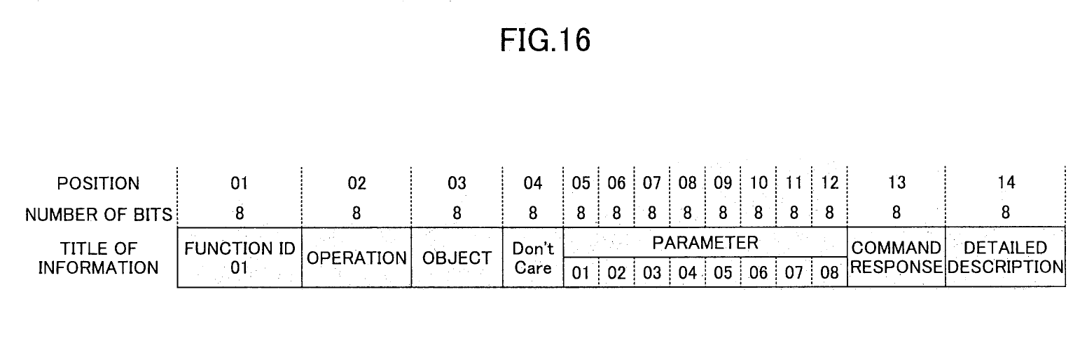

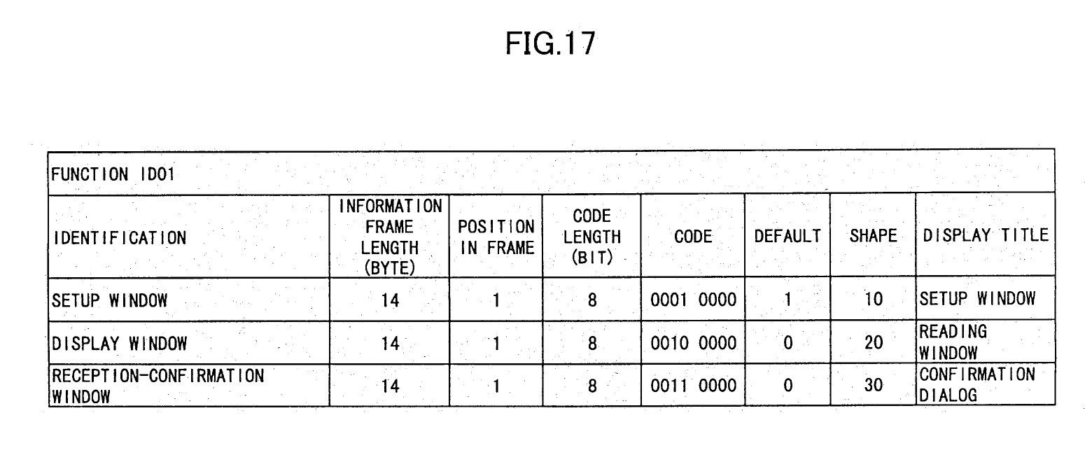

FIG. 12A indicates the function editorial window We and the function information file Wi in the background wherein “FUNCTION ID” of the function information file is dragged and dropped in the function editorial window We. The pull-down menu of the candidates of functions is further displayed. Since “SETUP WINDOW” is selected, the setup window Ws is further displayed on the function editorial window We. As a result, as showed in FIG. 12B, a code 0001000 (see FIG. 17) corresponding to the “SETUP WINDOW” is placed at the position of “FUNCTION ID01” of the frame format (showed in FIG. 16).

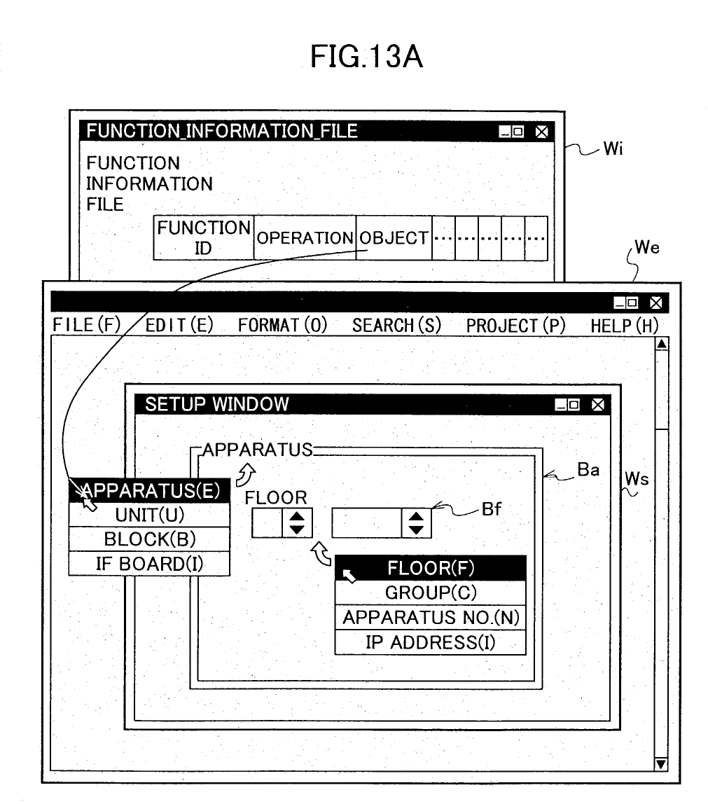

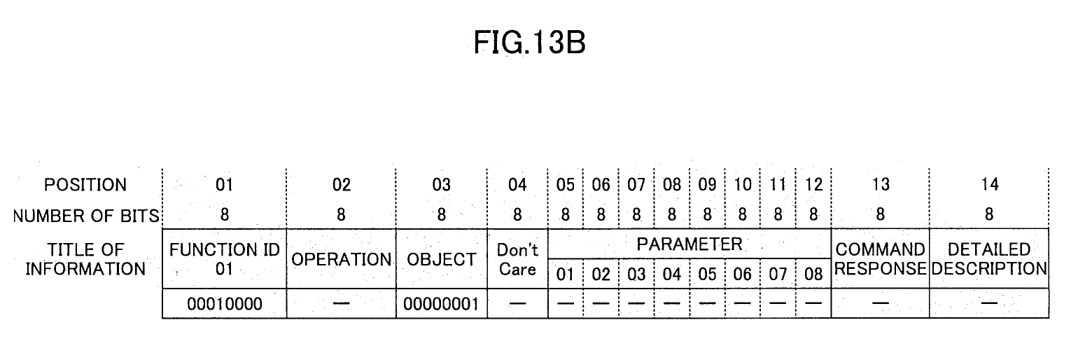

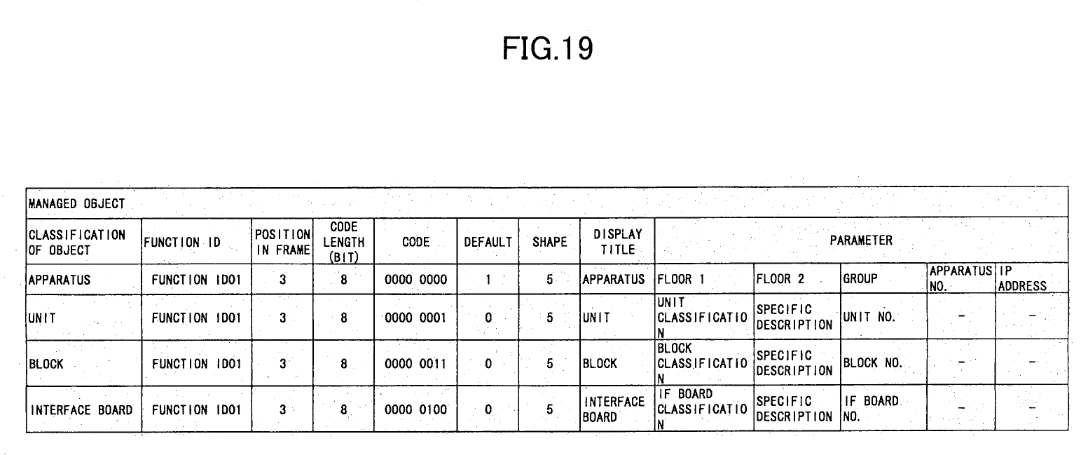

FIG. 13A shows the case wherein the item “OBJECT” is further dragged from the function information window Wi and dropped in the setup window Ws. The pull-down menu shows candidates of the object to be controlled, and the item “apparatus” is selected. An “apparatus” box Ba is displayed on the setup window Ws. Furthermore, the pull-down menu of parameters associated with the object “apparatus” is displayed in the “apparatus” box by right-clicking at an arbitrary position of the “apparatus” box. Since the item “floor” is selected, a block “floor” Bf is displayed. As a result, as showed in FIG. 13B, a code 00000001 (see FIG. 19) is put in the position “controlled object” of the frame format.

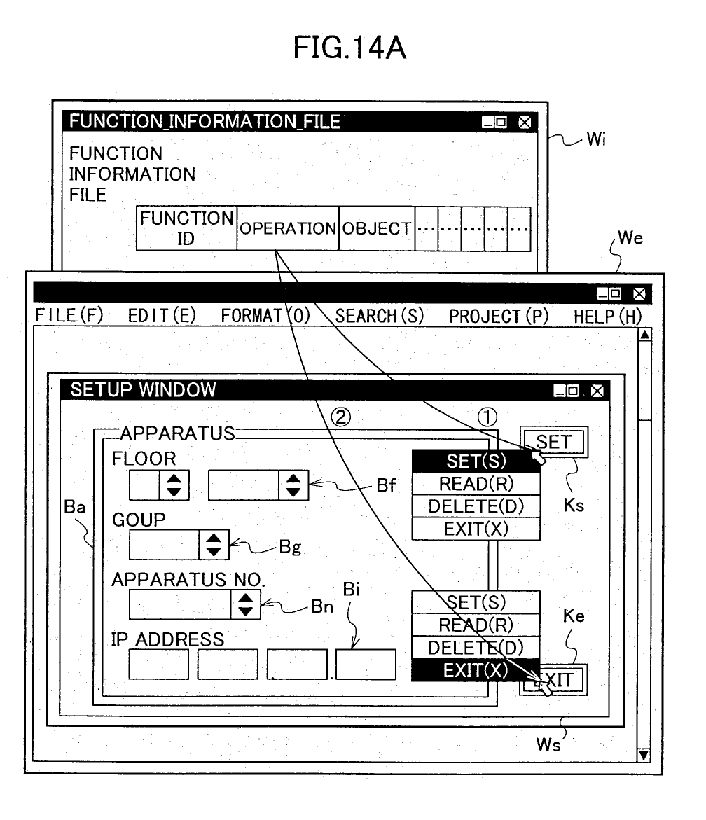

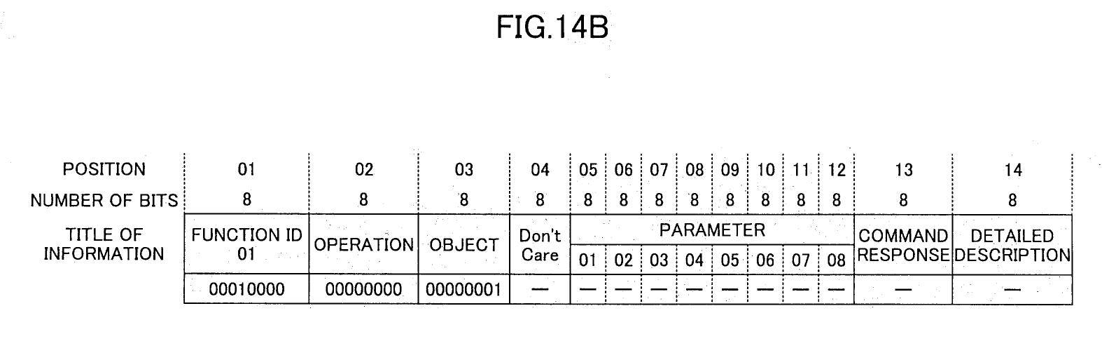

Furthermore, FIG. 14 shows the case wherein the item “OPERATION” is dragged from the function information window Wi and dropped at an arbitrary position in the “setup” window Ws. A pull-down menu of operations is displayed by right-clicking, and “setup” and “exit” buttons Ks and Ke are created.

When the setup window Ws (showed in FIG. 15A) is opened from the main window as described above, the function performance unit 200 loads, in the memory, a setup frame (control frame) in which the “setup” code is put at the position of function ID and the “apparatus” code is put at the position of the controlled object. The function performance unit 200 writes input data in each item of the setup frame by following the operator's operation. When the setup button Ks is clicked, the function performance unit 200 writes a “setup” code at the position of “operation”, and activates the executable program module 110 (showed in FIG. 7B) that transmits the setup frame.

As described above, the management window is created using the information items of the information frame stored in the function information file. When the function performance unit performs a management operation on a managed apparatus, the function performance unit retrieves the parameters stored in the function information file 400 and runs a corresponding program module. The parameters retrieved from the function information file are assured to fit the specifications, such as platform and interface, of the managed apparatus. Since an appropriate information frame is transmitted to the managed apparatus depending on its specifications, the managed apparatus can process the information frame and respond to it without much delay.

FIGS. 16 through 32 are schematic drawings showing the contents of the function information file. FIG. 7B is a block diagram illustrating the structure of the function performance unit 200 that performs managerial operations using the performance information file 500 created by a method of performing a managerial operation according to an embodiment of the present invention FIG. 17 is a table of items that is set up at the position of the “function ID” of the frame showed in FIG. 16. This table defines various windows and their function types that are the basis of the performance information file. This table includes the following columns.

“Identification” indicates the name of functions.

“Information frame length” indicates the effective length (bytes) of an information frame.

“Position in frame” indicates the position of the code in the information frame.

“Code length” indicates the effective length (bits) of the code that is unique for each function.

“Code” indicates the binary code that is unique for each function.

“Default” indicates whether a function is default. “1” indicates that the function is default.

“Shape” indicates the shape of a window or a dialog box that is specified separately.

“Display title” indicates the title to be indicated in the title bar of the window or the dialog box.

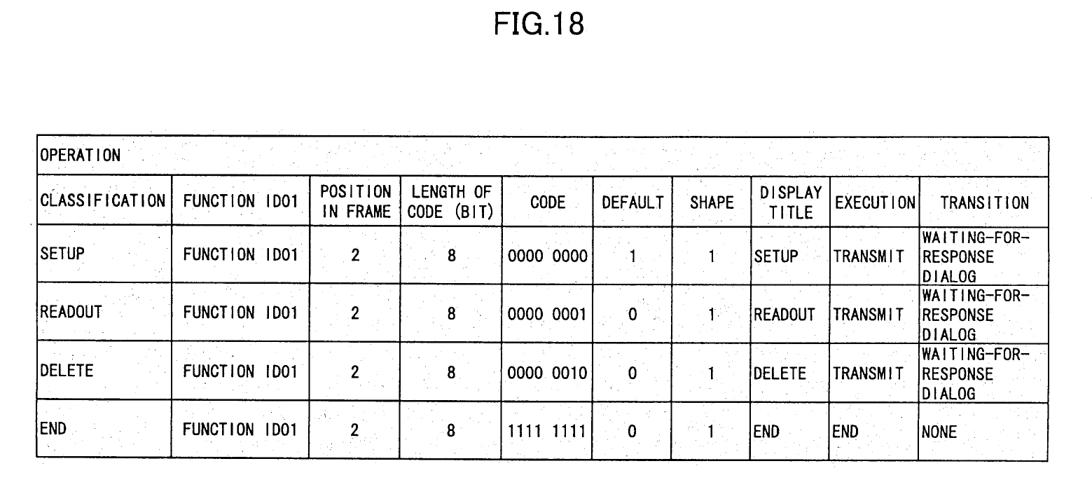

FIG. 18 is a table of items that is set up at the position of the “operation” of the frame showed in FIG. 16. This table defines an operation that is performed in response to the performance information file. This table includes the following columns.

“Classification” indicates operations that are performed in response to the performance information file.

“Function ID” indicates the function ID in which the operation is assignable.

“Position in frame” indicates the position of the code in the information frame.

“Code length” indicates the effective length (bits) of the code that is unique for each operation.

“Code” indicates the binary code that is unique for each operation.

“Default” indicates whether a function is default. “1” indicates that the function is default.

“Shape” indicates the shape of a window or dialog button that is specified separately.

“Display title” indicates the title to be indicated in the window or dialog button.

“Execution” indicates a program module that is executed upon operation.

“Transition” indicates a window or a dialog after the operation is performed (after the program module is executed).

FIG. 19 is a table of items that is set up at the position of the “managed object” of the frame showed in FIG. 16. This table defines the objects that are managed based on the performance information file. This table includes the following columns.

“Classification of object” indicates the objects that are managed.

“Function ID” indicates the function ID that is set up.

“Position in frame” indicates the position of the code in the information frame.

“Code length” indicates the effective length (bits) of the code that is unique for each object.

“Code” indicates the binary code that is unique for each object.

“Default” indicates whether an object is selected in case of default when a frame ID is selected and dropped. “1” indicates that the object is default.

“Shape” indicates the shape of a button box or a window dialog that is specified separately.

“Display title” indicates the title to be indicated in the window or dialog.

“Parameter” indicates a set of parameters for managing the managed object.

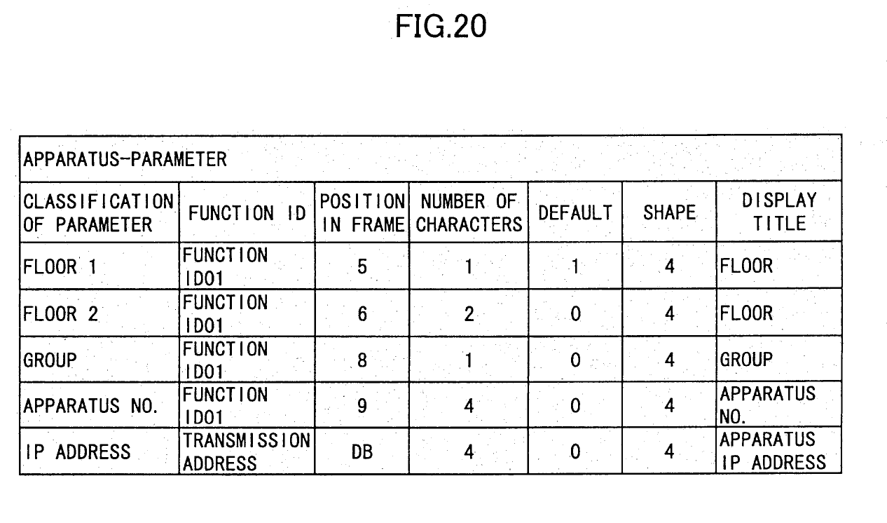

FIG. 20 is a table of items that is set up at the position of the “parameter” of the frame showed in FIG. 16. This table defines the parameters of the managed object that is selected above. This table includes the following columns.

“Classification of parameter” indicates parameters to be set up on the managed object.

“Function ID” indicates the function ID that is set up. In the case of “IP address”, the IP address of the managed object to which the information frame is transmitted.

“Position in frame” indicates the position of the parameter in the information frame. In the case of “IP address”, “position” is “DB” indicating that the setup frame information is stored in a database.

“Number of characters” indicates the number of characters used to indicate the setup value of the parameter. The size of edit boxes Ba, Bf, Bg, Bn, and Bi, for example, is determined based on this number.

“Default” indicates whether a parameter is selected in case of default when a frame ID is selected and dropped. “1” indicates that the parameter is default.

“Shape” indicates the shape of a button box or a window dialog that is specified separately.

“Display title” indicates the title to be indicated in a box.

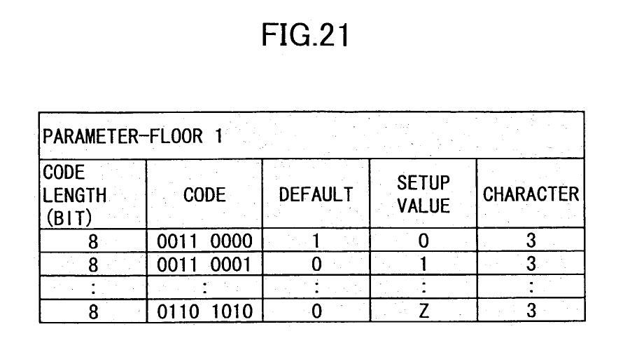

FIGS. 21-25 indicate specific contents of the above parameters.

FIG. 21 is a table used for selection of “floor 1” of remote buildings. This table includes the following columns.

This parameter is indicated by numerals 1-9 and alphabets A-Z.

“Code length” indicates the effective length (bits) of the parameter.

“Code” indicates the binary code that is unique for each floor. For example, the code “00110000” corresponds to the floor “0” and the code “00110001” corresponds to the floor “1”.

“Default” indicates whether a floor is selected in case of default when a parameter “floor 1” is dropped. “1” indicates that the floor is default.

“Setup value” indicates a value that is set at the parameter “floor 1”.

“Character” indicates the classification of characters used to set up the parameter defined separately.

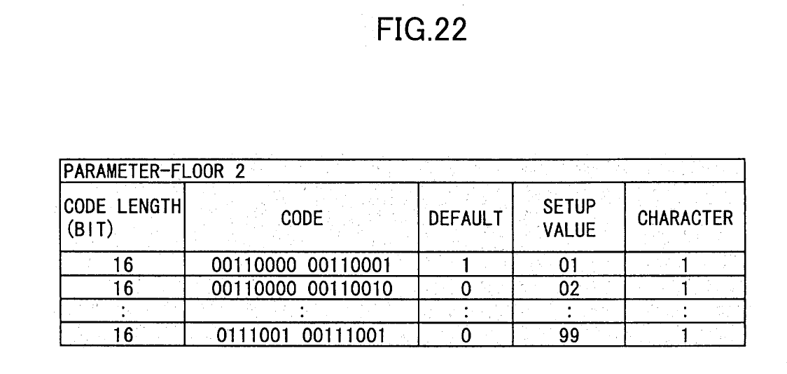

FIG. 22 is a table used for selection of “floor 2” in the same manner as FIG. 21. This table defines parameters related to “floor 2”. The contents of this table are identical to the table showed in FIG. 21. “Setup value” ranges between 00 and 99.

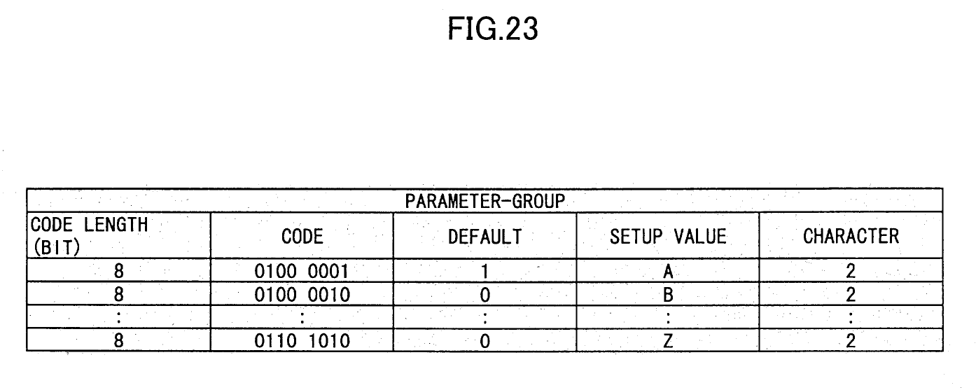

FIG. 23 is a table used to select a “group”. A “group” is identified by a “setup value” A-Z, and a binary “code” uniquely corresponds to the “setup value”. The other columns of this table are identical to those of the tables showed in FIGS. 21 and 22.

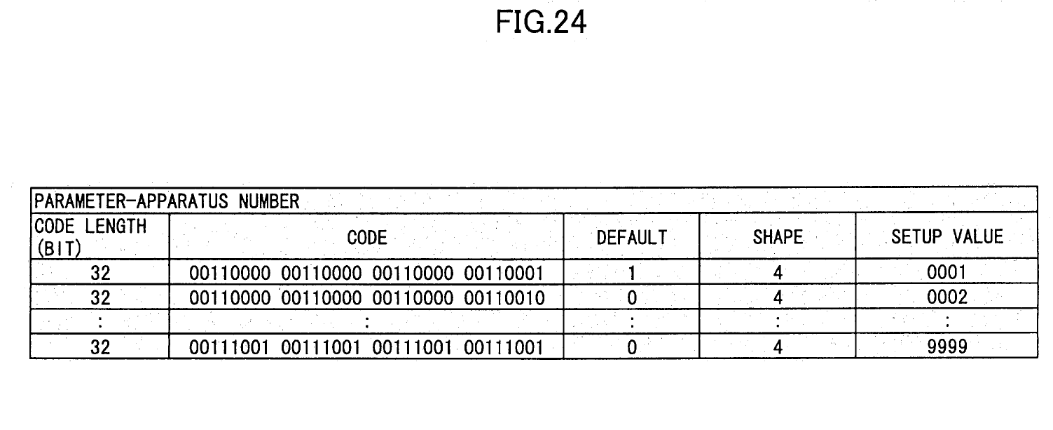

FIG. 24 shows a table used to select an “apparatus number”. An “setup value” is a unique number assigned to each managed apparatus for identification. The “setup value” is a four-digit numeral 0000-9999 in this case. A binary “code” also uniquely corresponds to each managed apparatus. The other columns “code length”, “default”, and “shape” are the same as above.

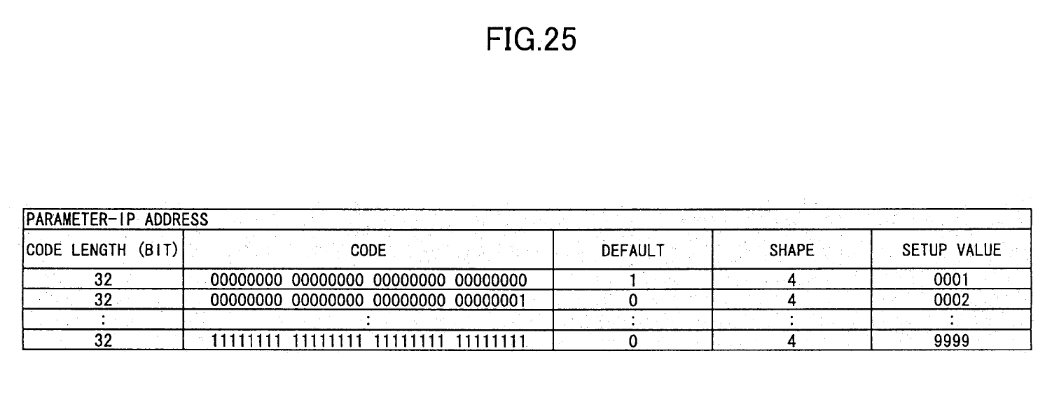

FIG. 25 shows a table used to select an “IP address” of a managed apparatus. The IP addresses are listed in the column “code”, and a “setup value” 0000-9999 uniquely corresponds to each IP address. The other columns “code length”, “default”, and “shape” are the same as above.

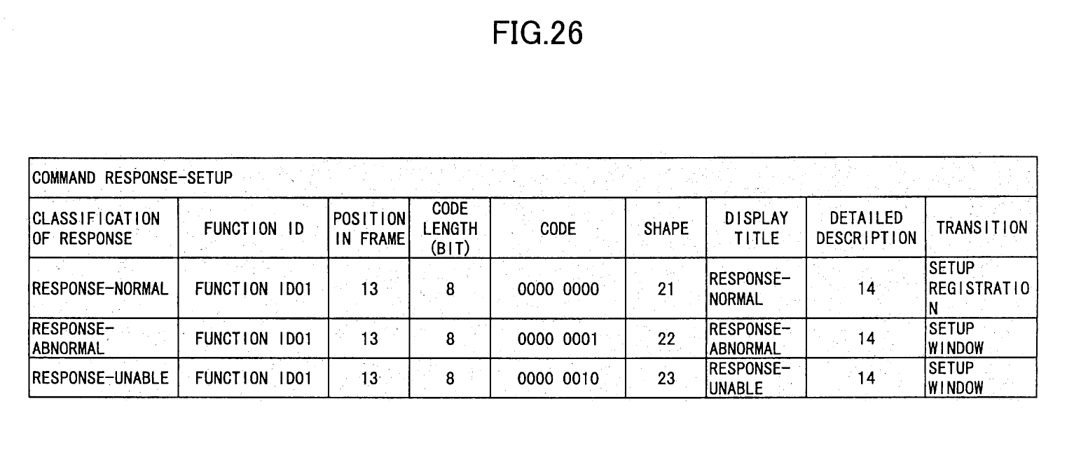

FIGS. 26-29 show tables related to the field “response to command” in the performance information file.

FIG. 26 shows a table indicating what to do in response to a reception of a response frame. This table includes the following columns.

“Classification of response” indicates the response from the managed apparatus.

“Function ID” indicates the function ID corresponding to each response command.

“Position in frame” indicates the position of the code in the information frame.

“Code length” indicates the effective length (bits) of a code.

“Code” is a binary code to identify the response.

“Shape” indicates the shape of a button box or a window dialog that is specified separately.

“Display title” indicates the name of the response that is showed in the window or dialog box.

“Detailed description” indicates the contents of the “detailed description” frame.

“Transition” indicates a window or a dialog the function performance unit 200 moves to in response to the completion of the operation (after the executive program module is executed).

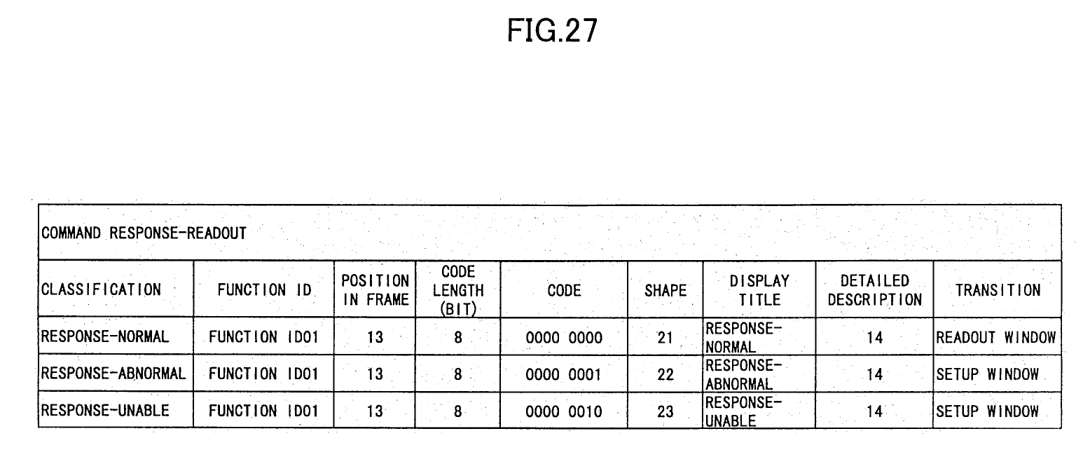

FIG. 27 shows a command response-readout table. This table indicates whether the function performance unit performs reading (normal) or terminates the process and returns to the setup window (abnormal/non-executable). The contents to be input are the same as FIG. 26.

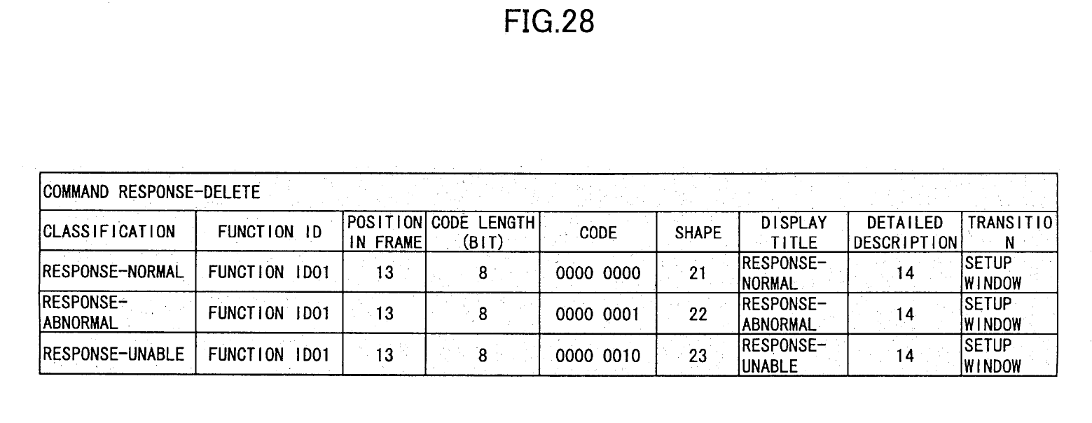

FIG. 28 shows a table indicating the operation to be performed in response to a reception of command response from a managed apparatus. The contents to be input are the same as FIG. 26.

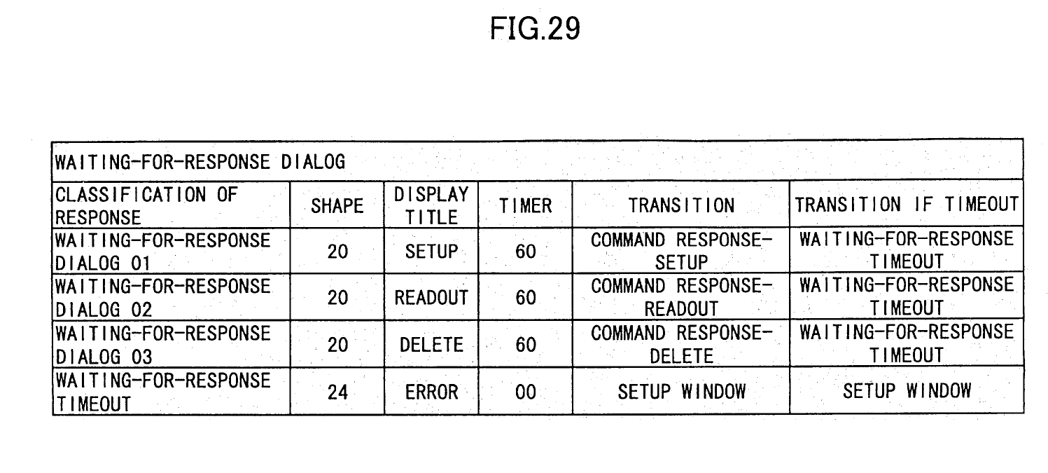

FIG. 29 shows a table of waiting-for-response dialog. This table defines the case in detail wherein the function performance unit moves to waiting-for-response time out and let the operator confirm. The contents of the table are as follows.

“Classification of response” indicates the name of response of received information from the managed object.

“Shape” defines the size of the dialog box of which details are specified separately.

“Display title” is indicated in the window or the dialog.

“Timer” is a time period (seconds) for which the function performance unit 200 waits for a response. If “timer value” is “00”, the timer is not activated.

“Transition” is the window or dialog to which the function performance unit 200 moves when it receives a response within the time limit.

“Transition if timeout” is the window or dialog to which the function performance unit 200 moves when it fails to receive a response within the time limit. An “OK” button is disposed in the timeout dialog.

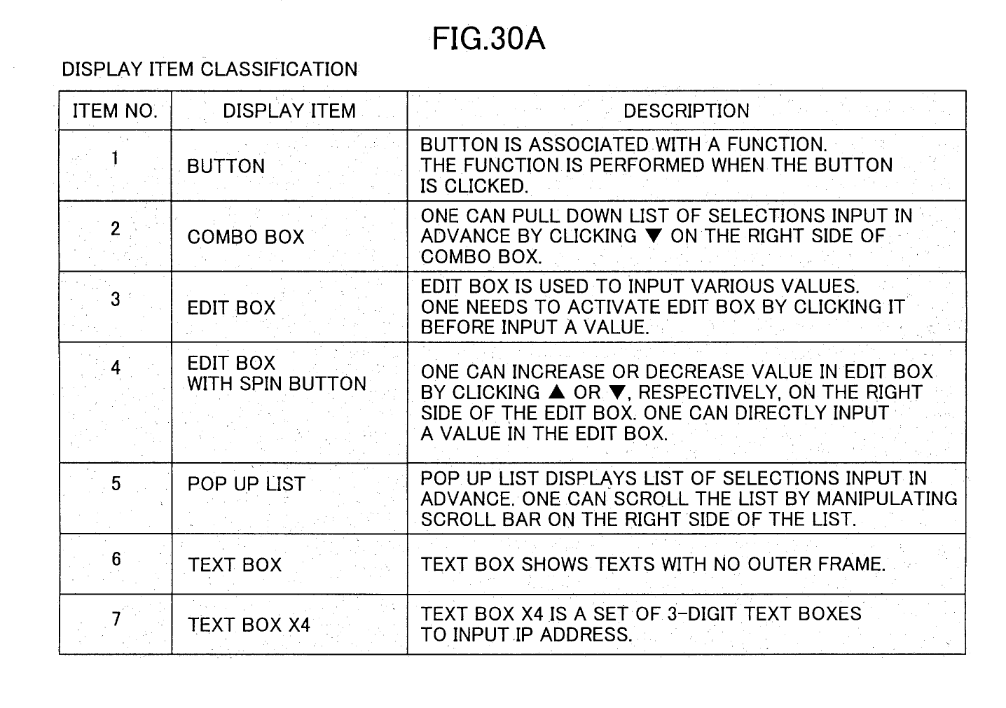

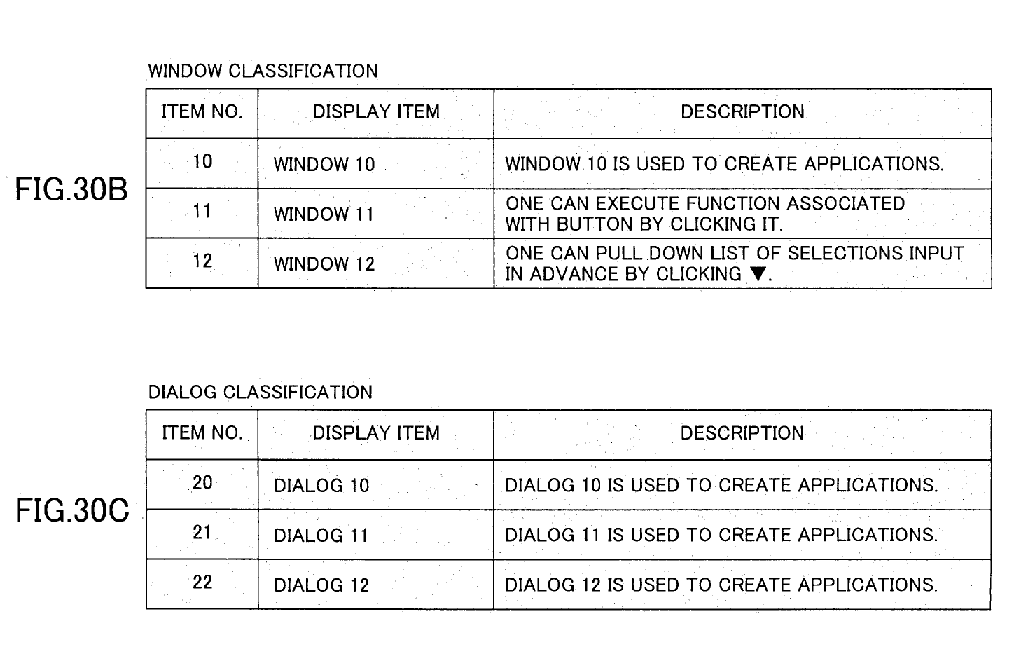

FIGS. 30A, 30B, and 30C show tables of various display items specified by “shape” as described above. The function performance unit 200 stores these display items therein and displays a display item based on the item number, title, and designated size specified by the previous function.

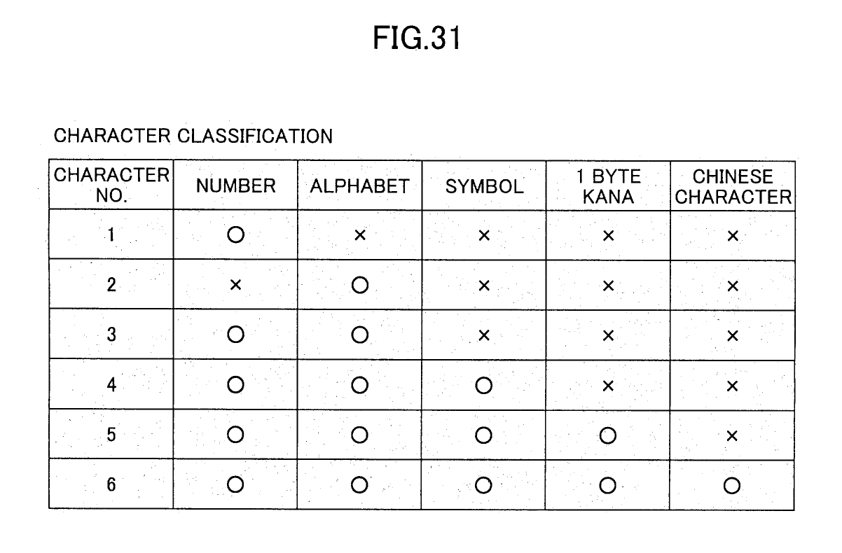

The above character information is also stored in the function performance unit. The function performance unit displays screens (windows) using a usable character set designated by the character set number. The function performance unit further checks characters input by the operator by reference to the usable character set. FIG. 31 shows a table indicating usable character sets.

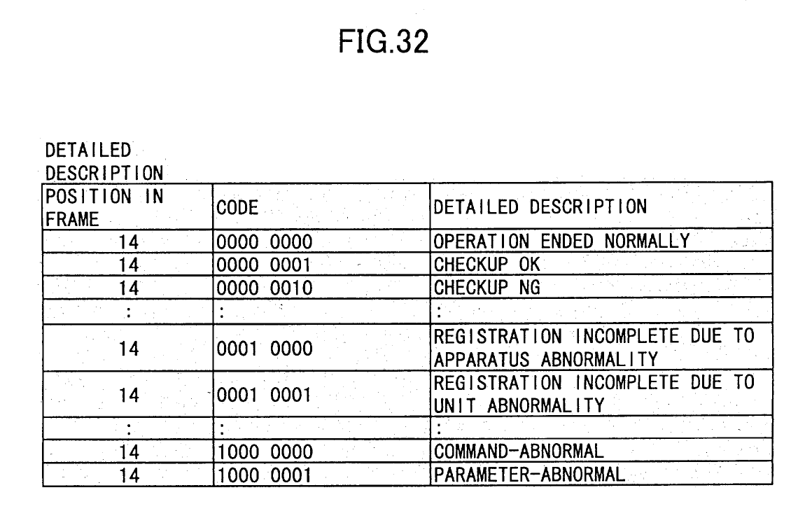

The “detailed description” of the information frame is coded by an 8-digit binary code. The 8-digit binary codes are listed with corresponding detailed descriptions in a “detailed description” table according to an embodiment showed in FIG. 32. When the function performance unit receives a detailed description code, corresponding detailed description is displayed in the screen by reference to this table. “Frame position” indicates the position of the code in the information frame. In another embodiment, the frame position may be changed if the position of the code is changed in the information frame.

The preferred embodiments of the present invention are described above in connection with the management of a network system. The present invention is not limited to these embodiments, but various variations and modifications may be made without departing from the scope of the present invention.

This patent application is based on Japanese priority patent application No. 2002-00120-7 filed on Jan. 8, 2002, the entire contents of which are hereby incorporated by reference.

What is claimed is:

1. A method of performing a control operation on a target apparatus, comprising:
a step of creating a function information file describing control functions of said target apparatus;
a step of forming a control window by gathering the control functions stored in said function information file;
a step of storing said control window in a performance information file; and
a step of performing said control operation by retrieving said control window from said performance information file.

2. The method as claimed in claim 1, wherein said step of forming said control window further comprises a step of disposing a set of control functions stored in said function information file on an editorial screen.

3. The method as claimed in claim 1, wherein said function information file further describes an order for implementing each control function.

4. The method as claimed in claim 1, wherein said function information file further describes shape and titles of a window, a dialog box, and an icon for implementing each control function stored in said function information file.

5. The method as claimed in claim 1, wherein
said function information file further describes a link between each control function and specific information of parameters; and
said step of performing said control operation further comprises a step of checking parameters by linking to said specific information of said parameters when performing said control operation.

6. The method as claimed in claim 1, wherein said function information file further describes classification and length of a transmission frame that is transmitted to said target apparatus.

7. The method as claimed in claim 1, wherein said function information file further describes a frame position, code length, and a code of each control function.

8. The method as claimed in claim 1, wherein said function information file further describes possible responses to an information frame transmitted to said target apparatus and respective destinations of transition.

9. The method as claimed in claim 1, wherein said function information file further describes a time limit to wait for a response frame and a destination to transition to if a response frame is not received within said time limit.

10. The method as claimed in claim 1, wherein said function information file further describes a reference to information about display items.

11. The method as claimed in claim 1, wherein said step of performing said control operation further comprises a step of determining a display item and a destination of transition depending on a given time limit.

12. The method as claimed in claim 1, said step of performing said control operation further comprises a step of displaying the control window by referring to table information stored in the performance information file.

13. An apparatus that performs a control operation on a target apparatus, comprising:
a function editing unit that forms a control window by gathering control functions stored in a function information file describing control functions of said target apparatus; and
a performing unit that performs said control operation by retrieving said control window from a performance information file.

14. The apparatus as claimed in claim 13, wherein
said function information file further describes a link between each control function and specific information of parameters; and
said performing unit further checks said parameters by linking to said specific information of said parameters when performing said control operation.

15. The apparatus as claimed in claim 13, wherein said function information file further describes classification and information length of an information frame that is transmitted to said target apparatus.

16. The apparatus as claimed in claim 13, wherein said function information file further describes a frame position, code length, and a code of each of the control functions.

17. The apparatus as claimed in claim 13, wherein said function information file further describes possible responses to an information frame transmitted to said target apparatus and respective destinations of transition.

18. The apparatus as claimed in claim 13, wherein said function information file further describes a time limit to wait for a response frame and a destination to transition to if the response frame is not received within said time limit.

19. The apparatus as claimed in claim 13, wherein said function information file further describes a reference to information about display items.

20. The apparatus as claimed in claim 13, wherein said performance information file further describes shape and title of said control window.
